(19) United States
(12) Patent Application Publication
(10) Pub. No.: US 2002/0114438 A1
(43) Pub. Date: Aug. 22, 2002

(54) Personal database in a telephone network for managing contact information

(76) Inventor: Seshu Ganugapati, Lowell, MA (US)

Correspondence Address: DENIS G. MALONEY, Fish & Richardson P.C., 225 Franklin Street, Boston, MA, 02110-2804, US

(21) Appl. No.: 09/788,783

(22) Filed: Feb. 20, 2001

(51) Int. Cl. H04M 3/42

(52) U.S. Cl. 379/201.01; 379/218.01

(57) ABSTRACT

A method for managing contact information including telephone numbers over a telephone network is described. When initiated by an authorized user during a connection to another party, the method announces an appropriate recorded message via a telephone network to prompt the party to enter a telephone number. The method stores the telephone number in an assigned portion of a database to which the authorized user have access via the telephone network, and retrieves and deletes the telephone number at a request submitted by the authorized user via the telephone network.

### TECHNICAL FIELD

This invention relates to services provided in telephone network.

### BACKGROUND

Although many forms of telecommunication are available today, those based on a plain ordinary telephone (POT) system still dominate the market of voice communication systems. The telephone system, including wire-lined and wireless communication links, establishes telephone connections between calling parties, and provides telephone services including, for example, call waiting, 3-way calling, call forwarding, and conference calling.

### SUMMARY

It is common that people exchange contact information, such as telephone numbers, during a telephone call. The telephone call may occur while these people are mobile or away from their desks, such as in elevators, on escalators, or at airports. For example, a Party A may call a Party B for a business conversation. During the conversation, Party B indicates that Party C could be an important business contact and recites Party C's phone number. Party A unfortunately does not have a pen and a piece of paper available to write down Party C's phone number. Party A might have to give up Party C's phone number, or call Party B at a later time. However, the later phone call is not guaranteed to happen if Party B is always busy or hard to reach.

According to an aspect of the present invention, a method of managing contact information includes prompting a party for an information entry when initiated by an authorized user connected to the party, and storing the information entry in an assigned portion of a database to which the authorized user have access via the telephone network. The assigned portion of the database also includes other information entries. The method further includes retrieving and deleting the response at a request submitted by the authorized user via the telephone network.

According to another aspect of the present invention, a system for managing contact information includes a switch module to provide a connection between an authorized user and a party in a network. The switch module is adapted to announce an appropriate recorded message to prompt the party for an information entry when initiated by the authorized user during the connection. The system further includes a database that stores the information entry or other information entries at a request of the authorized user. A portion of the database is assigned to the authorized user. The system still further includes a telephone network, through which the information entry and the request are sent.

According to an additional aspect of the present invention, a computer program product residing on a computer readable medium for managing contact information entered over a communication system comprises instructions for causing a computer to announce an appropriate recorded message received over a telephone network to prompt a party for an information entry, when initiated by an authorized user connected to the party; store the information entry in an assigned portion of a database that the authorized user has access via the telephone network, the assigned portion including other information entries; and retrieve and delete the information entry at a request submitted by the authorized user via the telephone network.

Embodiments of the above aspects of the invention may include one or more of the following features.

The method further includes announcing an appropriate recorded message via a telephone network to the parties, for prompting one of the parties to enter an information entry. The information entry entered by the party is a telephone number, which can be entered by pressing number buttons on a touch-tone telephone, or by directly speaking into a telephone. After the response is entered, the system further announces the response to the party for confirmation. The party can then choose to save, re-enter, or cancel the response.

The system further informs the authorized user of amount of unoccupied space in the assigned portion of the database, to allow the authorized user to delete some of the occupied space for storing the response. The response can be stored after the authorized user disconnects himself from the party but when the party is still connected to the database; or while the authorized user, the party, and the database are connected.

Embodiments may have one or more of the following advantages. The method, the system, or the computer program product allows an authorized user to store contact information, such as phone numbers, into a personalized database during a telephone connection. The personalized database is an assigned database that works like a scratch pad. The authorized user can retrieve or delete the information at a later time. The user effectively has a personalized phone book on his telephone, and can be assured that the phone numbers stay in the database until he deletes them. The user does not need a pen or a piece of paper when he wishes to write down a phone number, and does not need to worry about losing the paper if he is traveling.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a system diagram illustrating a plurality of central and local offices connected by a backbone telephone network to provide services to users;

FIG. 2 is a diagram of the local office that includes a database for storing phone numbers and a switch for executing software to provide Personal Phonebook Service (PPBS);

FIG. 3 is a diagram showing portions of the database assigned to users;

FIG. 4 illustrates announcement messages in an interactive announcement software executed by the switch of FIG. 2;

FIG. 5 is a flow diagram illustrating a process of storing phone numbers during a phone conversation between an authorized user and another party; and

FIG. 6 is a flow diagram illustrating a process of storing phone numbers after an authorized user exits from a phone conversation with another party.

### DETAILED DESCRIPTION

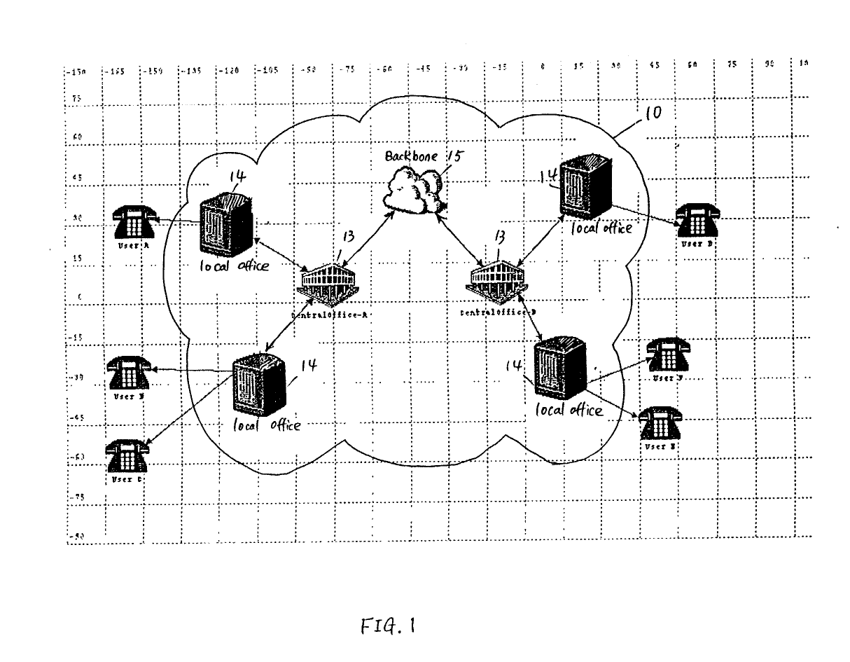

Referring to FIG. 1, a telephone system 10, including a backbone telephone network 15, central offices 13 and local offices 14, connects to a plurality of users to provide telephone services. Local offices 14 establish telephone connections within their respective local areas, and route long distance calls to their destinations by forwarding them to appropriate central offices 13. Central offices 13 are linked to each other by backbone telephone network 15, which has high speed and large bandwidth, and is capable of serving over tens of thousands of long distance connections. Each of the local or long distance connections carries voice signals, fax, or data, and is transmitted over wire lines or wireless medium.

Telephone system 10 manages telephone connections by routing calls through central 13 and local offices 14. When one user, Party A, calls another user, Party B, a connection request from Party A is sent to local office 14 in Party A's local calling area. Local office 14 determines, according to Party B's phone number, if the call is local to its calling area, or has to be routed to other calling areas via central offices 13 and backbone telephone network 15 to reach Party B.

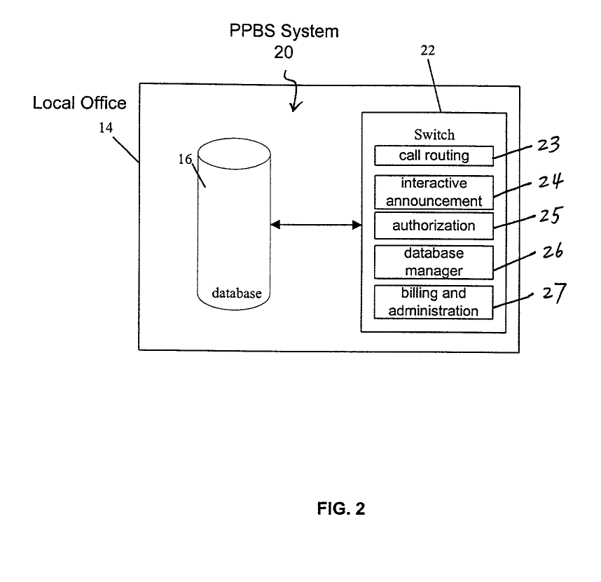

Referring to FIG. 2, local office 14 includes a switch 22 and a database 16 connected by a Local Area Network (LAN) 29. Switch 22 handles call requests from the users to establish telephone connections between the users. Processing speed of switch 22 and size of database 16 affects the number of calls that local office 14 can handle. Database 16 can be dedicated to the switch unit 22 located in the same local office 14, or can be shared by a plurality of switch units 22 in different local offices 14. Switch 22 and database 16 together with appropriate software form a Personal Phonebook Service system 20 (PPBS system) that offers a Personal Phonebook Service (PPBS), as described below, in addition to basic telephone connection services.

Switch unit 22 processes embedded programs or application software to provide service to users. The programs or software generally include functions such as call routing 23, interactive announcement 24, authorization 25, database manager 26, and billing and administration 27. Call routing 23 routes incoming calls to their destinations as described above. Interactive announcement 24 announces recorded messages in response to a user's actions, and is designed to guide or confirm the user's operations. Telephone services that use interactive announcement 24 include voice mail, directory assistance, and the Personal Phonebook Service (PPBS). Authorization 25 verifies a user's identity for accessing subscribed services. Database manager 26 manages data access to database 16, thus allowing a PPBS subscriber to store, retrieve, and delete data in database 16. Billing and administration 27 handles telephone billing and other administrative tasks.

The PPBS service is provided by a telephone company to allow subscribers, or authorized users, to store a plurality of contact information entries, e.g., telephone numbers, in database 16. The authorized users can have the telephone numbers stored during a telephone conversation with another party, and retrieve and delete the telephone numbers at a later time. A portion of database 16 is assigned and dedicated to the authorized user. When the assigned portion is used to store telephone numbers, it is like a personal database containing a personal phonebook.

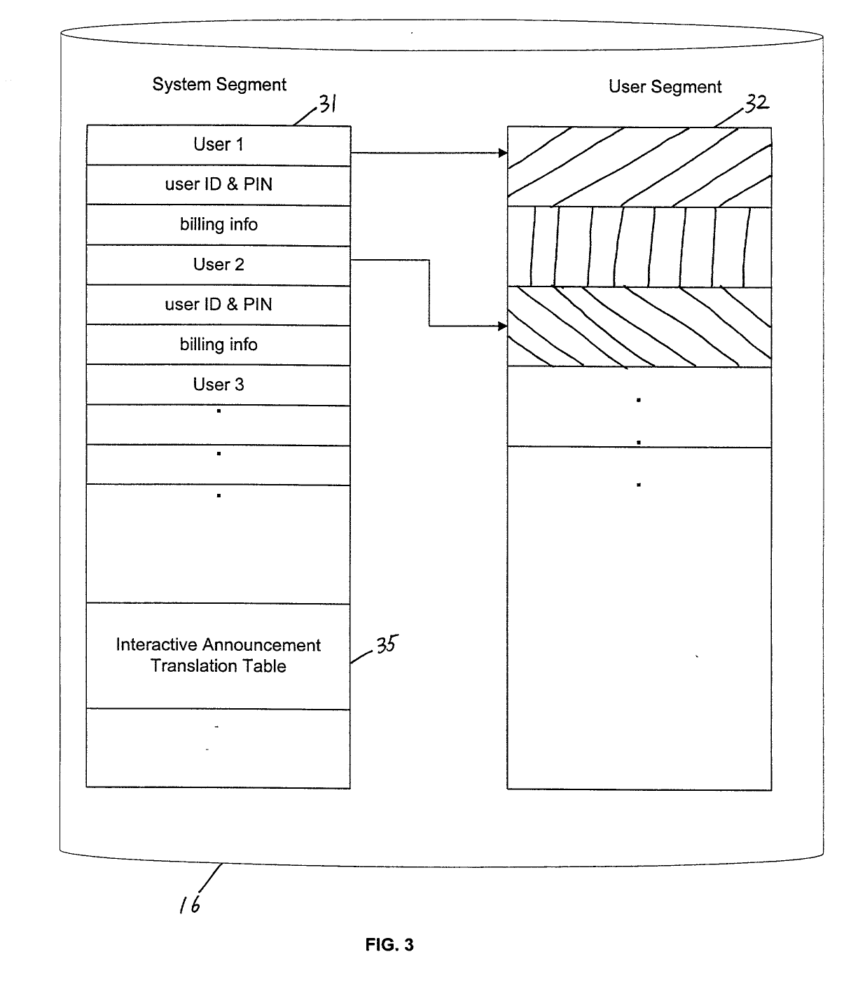

Referring to FIG. 3, database 16 includes a system segment 31 and a user segment 32. System segment 31 is accessible to system administrators, and stores administrative information and user records, such as billing data. If a user subscribed to the PPBS, the user's record will additionally stores his user ID, PIN, and a pointer to an assigned portion in user segment 32. System segment 31 further includes an interactive announcement translation table 35 used by interactive announcement 24.

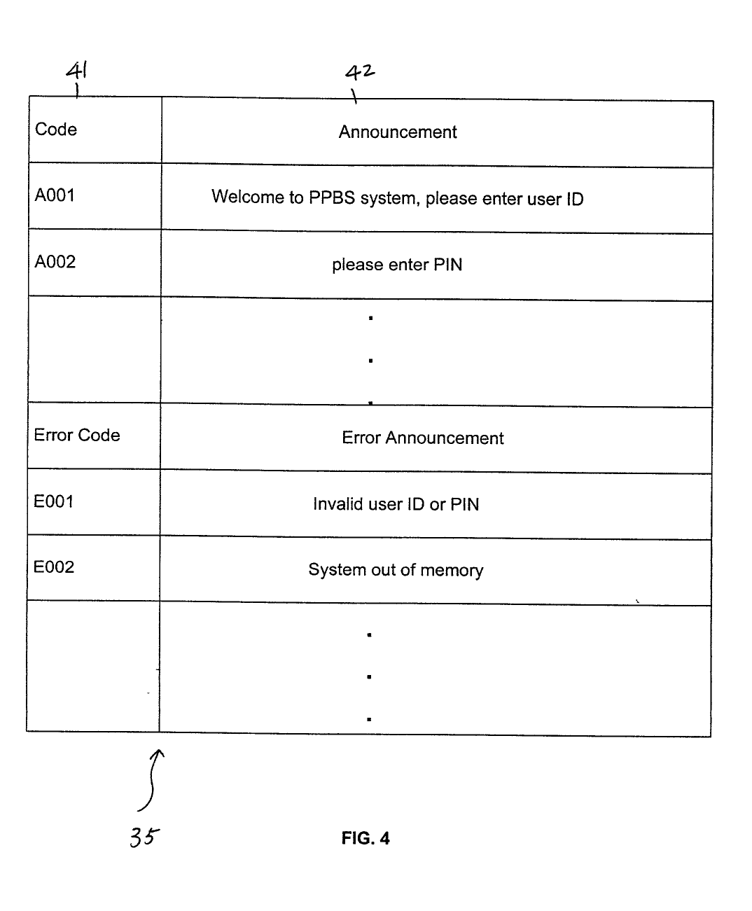

Referring to FIG. 4, interactive announcement translation table 35 contains codes 41 and announcement messages 42 used by PPBS system 20 to guide users during data access, or to indicate error conditions. Error conditions occur, for example, when an invalid option is entered or when the assigned database is full.

Referring back to FIG. 3, user segment 32 is accessible to authorized users. User segment 32 includes assigned portions, each assigned to an authorized user and containing a plurality of contact information entries (e.g., telephone numbers). The contact information entries are stored at a request of the authorized user while the user is on a phone conversation with another party, as will be described in detail below.

As an example, assume that a call from Party A is successfully routed to Party B, and a voice connection is established between the two parties. Further assume that Party A subscribes to the PPBS. At some point during the connection, Party A needs to obtain phone numbers of a Party C from Party B. Without terminating the connection, Party A can have the phone numbers recorded in an assigned portion of database 16, in the forms of numbers or speech signals. Party A simply needs to enter his user ID and PIN, and interactive announcement 24 will announce one of the announcement messages 42 to guide both parties during the process of recording the phone numbers.

Security measures are taken in PPBS system 20 to ensure that both parties engaging in a telephone conversation are aware of the recording. Specifically, interactive announcement 24 will announce one of the announcement messages 42 stored in interactive announcement translation table 35, informing both parties that recording is taking place.

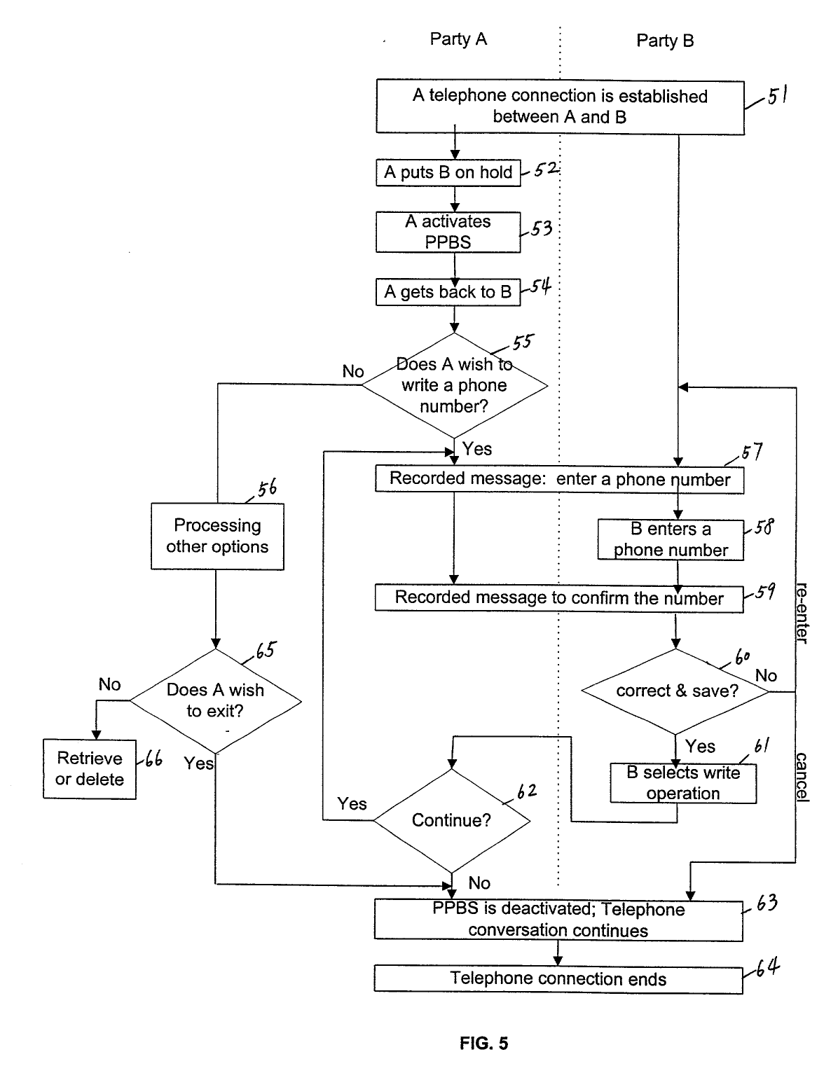

An illustrative example of the process to enter the numbers is described with reference to FIG. 5.

The parties establish a conventional telephone connection. This is established by Party A picking up his phone and hearing a dial tone. Party A dials Party B's phone number, and Party B hears his phone ring, picks up the phone and answers it. Party A responds to Party B, and a telephone connection is established 51 between the two parties.

During the conversation, Party A indicates to Party B that he wants a telephone number of a third party (e.g. Party C) from Party B. Party A is authorized to use the Personal Phonebook Service (PPBS) offered by the telephone service provider (e.g., Company XYZ).

In some embodiments, Party A can place Party B on hold 52. Party A dials a number, for example, 111-222-3333, which is given to him by Company XYZ. Party A then hears a recorded message prompt him for a user ID and a PIN. Once Party A's user ID and PIN are entered and verified, Party A successfully activates 53 the PPBS and logs into his assigned database. If either the user ID or PIN is incorrect, PPBS system 20 will force Party A to exit after a pre-determined number of attempts (e.g., two), and will announce “Please contact XYZ company for further assistance.”

After logging in, Party A gets Party B back on line 54. At this point, Party A can choose 55 one of several e.g., four options from a main menu, e.g.,

*81—write a phone number;

*82—retrieve a phone number;

*83—delete a phone number; or

*84—exit from database.

Continuing to talk to Party B, Party A chooses *81 to write a phone number. Party A and Party B both hear a recorded message announcing 57: “Please enter a telephone number and press # when finished.” Interactive announcement 24 also announces the amount of unoccupied space in Party A's database.

Party A requests Party B to enter the phone number (e.g., abc-efg-1234) from his telephone. Party B can either dial 58 the number buttons on a touch-tone telephone, or speak into the telephone directly.

Both parties hear another recorded message announcing 59, “You have entered phone number abc-efg-1234. Please select 60 one of the following options:

#1—correct and save;

#2—incorrect and re-enter; or

#3—cancel.”

“Cancel” option can be used when Party B realizes that he does not have Party C's phone number available after Party A has already activated the PPBS.

Party B presses #1 option to choose 61 “correct and save.”

Party A can then select 62 from the following options:

#1—continue; or

#2—exit.

If Party A chooses #1, he can request Party B to enter additional phone numbers. Otherwise, Party A can exit the PPBS by pressing #2.

After Party A chooses to exit, the PPBS is deactivated 63 for both parties. Party A and Party B are still connected and continue the conversation.

Party A or party B hangs up the phone to end 64 the telephone connection.

Additional features can be included in PPBS system 20 to allow Party B to enter a phone number after Party A hangs up the telephone. With the additional features, Party A does not need to stay connected for obtaining phone numbers from Party B. Party A can engage in other activities once the conversation is complete.

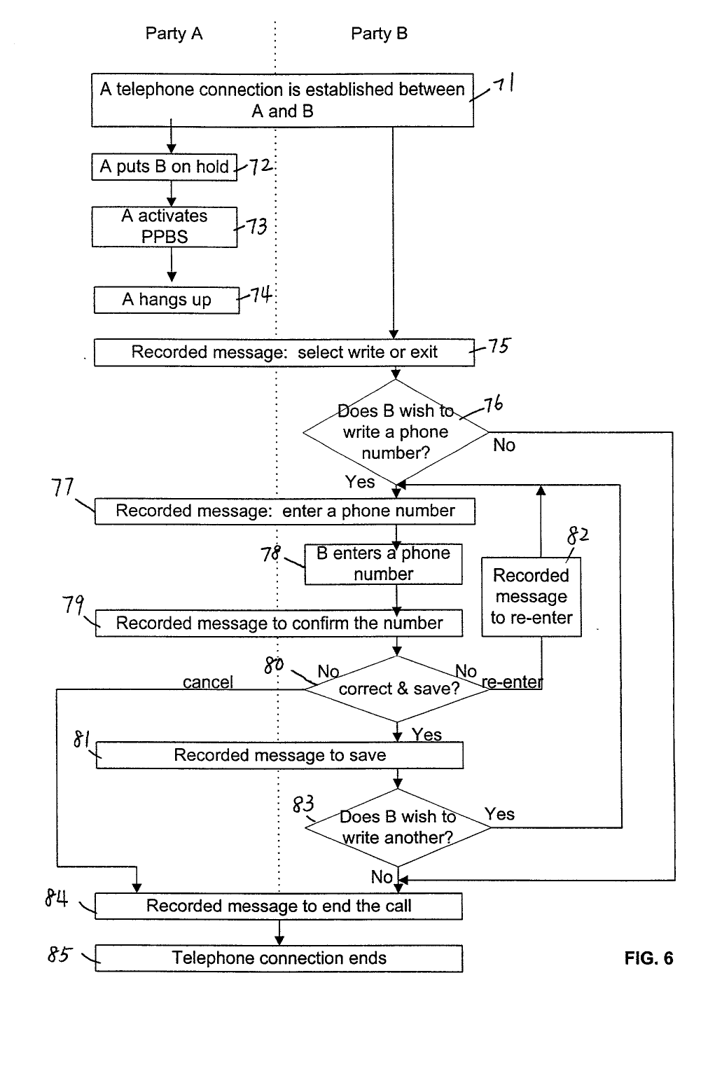

The following example, with reference to FIG. 6, illustrates a call process that uses the additional features. In the example the actions to establish a telephone call are the same as the ones in the above example, but the actions thereafter are modified as follows:

A telephone connection has been established 71 between Party A and Party B. Party A puts Party B on hold 72, or alternatively, activates a call transfer feature by entering a code. Party A then dials a number, for example, 111-222-3333, which is given to him by Company XYZ. Party A then hears a recorded message prompt him for a user ID and a PIN. Once Party A's user ID and PIN are entered and verified, Party A successfully logs into his assigned database and activates 73 the PPBS.

Now Party A hangs up 74 his telephone, leaving Party B in the telephone connection with the activated PPBS. Party B has restricted access to Party A's database, that is, Party B can only add phone numbers and verify them. Party B cannot access or modify other phone numbers in Party A's assigned database.

Party B hears a recorded message announcing 75: “Welcome to Party A's telephone database. Please select 76 one of the following options:

#1—write a phone number; or

#2—exit from database.”

Party B chooses #1 to write a phone number. Interactive announcement 24 requests 77, “Please enter the telephone number you wish to write down.” Party B enters 78 a phone number, e.g., abc-efg-1234. Interactive announcement 24 announces 79: “You have entered phone number abc-efg-1234. Please select 80 one of the following options:

#1—correct and save;

#2—incorrect and re-enter; or

#3—cancel.”

If Party B selects option #1 “correct and save”, interactive announcement 24 responds 81: “Your phone number has been successfully saved into Party A's personal phonebook. Please press:

#4—to write another phone number; or

#5—to exit.”

Party B can choose #4 to write another phone number by repeating 83 the process from Step (6.4), or exit 84 the PPBS.

If Party B selects option #2 “incorrect and re-enter”, interactive announcement 24 responds 82: “Please re-enter the phone number.” Then the process repeats. However, the number of re-enter attempts should be limited to avoid unnecessary waste of processing resources.

If Party B selects option #3 “cancel”, interactive announcement 24 responds 84: “Good bye, and thank you for using XYZ telephone company Personal Phonebook Service.”

If the PPBS is deactivated for Party B, Party B gets disconnected. The telephone connection is terminated 85.

It should be noted that in the second example where additional features are presented, an error condition would occur if there is not enough space in Party A's database to store additional phone numbers. Interactive announcement 24 will announce an error message and the PPBS will be automatically deactivated for Party B. The telephone connection will also be terminated. It is therefore Party A's responsibility to ensure that he has enough space in the database for additional phone numbers before hanging up the telephone.

It should also be noted that in the first example that Party A can free up space in his database even while he is in conversation with Party B. For example, assume that, while Party A and Party B are connected and the PPBS is activated, Party A's database is full. After Party B enters a phone number, interactive announcement 24 announces an error message, “Party A, PPBS is full. Please remove some phone numbers and try again.” At this point, Party A can free up storage space in the assigned database 16 with the following:

(1) putting user B back on hold,

(2) interacting privately with PBBS system 20 to delete phone numbers, and

(3) reconnecting to Party B by releasing the hold.

Techniques for Party A to review phone numbers, and to delete them to free up space is described below.

Referring again to FIG. 5, after logging in, Party A can choose 56 options *82, *83, or *84 to retrieve 66, to delete phone numbers, or to exit 65, respectively. If Party A is successfully logged onto PPBS system 20, and chooses *82 or *83 to retrieve or delete a phone number at step (6b), the following steps will be executed.

If Party A selects the option to retrieve a phone number, the interactive announcement 24 announces: “You received phone number abc-efg-1234 from Party B on Saturday, February the 3^{rd} (A time-stamped option can also be provided, e.g., 2:30 pm). Please press:

#2—to repeat the phone number;

#3—to delete the phone number;

#4—to go to the next phone number;

#5—to go to the main menu; or

#6—to exit the system.”

If party A selects the option to delete a phone number, the interactive announcement 24 announces: “You received phone number abc-efg-1234 from Party B on Saturday, February the 3^{rd} (A time-stamped option can also be provided, e.g., 2:30 pm). Please press:

#2—to confirm to delete the phone number;

#3—to cancel to delete the phone number;

#4—to go to the main menu.”

If Party A's telephone set has a call display (e.g., a caller ID display) for displaying phone numbers, the telephone set can incorporate application software for viewing phone numbers on the display as Party A retrieves or reviews phone numbers from his personal database.

A number of embodiments of the invention have been described. Nevertheless, it will be understood that various modifications may be made without departing from the spirit and scope of the invention. For example, the selectable options and the recorded messages used in the above examples may be replaced by other codes and messages to obtain the same results. These codes and messages can be selected by telephone companies for compatibility with their existing systems, and may vary from the ones in the above examples.

Accordingly, other embodiments are within the scope of the following claims.

What is claimed is:

1. A method of managing contact information comprising:
prompting a party for an information entry, when initiated by an authorized user connected to the party;
storing the information entry in an assigned portion of a database to which the authorized user have access via the telephone network, the assigned portion including other information entries; and
retrieving and deleting the response at a request submitted by the authorized user via the telephone network.

2. The method of claim 1 wherein the information entry and other information entries include telephone numbers.

3. The method of claim 1 further comprising informing the authorized user of amount of unoccupied space in the assigned portion of the database.

4. The method of claim 1 wherein the response is entered by pressing number buttons on a touch-tone telephone.

5. The method of claim 1 wherein the response is entered by directly speaking into a telephone.

6. The method of claim 1 wherein storing the response further includes announcing the response to the party after the response is entered.

7. The method of claim 1 wherein storing the response further includes allowing the party to re-enter the response.

8. The method of claim 1 wherein the method further includes accepting a cancel request from the party.

9. The method of claim 1 wherein storing the response occurs after the authorized user disconnects himself from the party but when the party is still connected to the database.

10. The method of claim 9 wherein the authorized user activates a call transfer feature before the authorized user disconnects himself from the party.

11. The method of claim 1 wherein storing the response occurs while the authorized user, the party, and the database are connected.

12. The method of claim 1 wherein prompting comprises: announcing an appropriate recorded message via a telephone network to the parties.

13. A system for managing contact information comprising:
a switch module to provide a connection between an authorized user and a party in a network, the switch module adapted to announce an appropriate recorded message to prompt the party for an information entry when initiated by the authorized user during the connection;
a database that stores the information entry or other information entries at a request of the authorized user, a portion of the database being assigned to the authorized user; and
a telephone network, through which the information entry and the request are sent.

14. The system of claim 13 wherein the information entry and other information entries include telephone numbers.

15. The system of claim 13 wherein the response is entered by pressing number buttons on a touch-tone telephone.

16. The system of claim 13 wherein the response is entered by directly speaking into a telephone.

17. The system of claim 13 wherein storing the response occurs after the authorized user disconnects himself from the party but when the party is still connected to the database.

18. The method of claim 17 wherein the authorized user activates a call transfer feature before the authorized user disconnects himself from the party.

19. The system of claim 13 wherein storing the response occurs while the authorized user, the party, and the database are connected.

20. The system of claim 13 further comprising a display on a telephone set connected to the telephone network for displaying the information entry for the authorized user.

21. A computer program product residing on a computer readable medium for managing contact information entered over a communication system comprises instructions for causing a computer to:
announce an appropriate recorded message received over a telephone network to prompt a party for an information entry, when initiated by an authorized user while being connected to the party;
store the information entry in an assigned portion of a database that the authorized user has access via the telephone network, the assigned portion including other information entries; and
retrieve and delete the information entry at a request submitted by the authorized user via the telephone network.

22. The computer program product of claim 21 wherein the information entry and other information entries include telephone numbers.
